(19) United States
(12) Patent Application Publication
(10) Pub. No.: US 2014/0324250 A1
(43) Pub. Date: Oct. 30, 2014

(54) VEHICLE PORTABLE KEY

(71) Applicants: Yosuke Tomita, Aichi (JP); Takahiro Inaguma, Aichi (JP)

(72) Inventors: Yosuke Tomita, Aichi (JP); Takahiro Inaguma, Aichi (JP)

(73) Assignee: OMRON AUTOMOTIVE ELECTRONICS CO., LTD., Aichi (JP)

(21) Appl. No.: 14/242,313

(22) Filed: Apr. 1, 2014

(30) Foreign Application Priority Data
Apr. 1, 2013 (JP) 2013-076498

(51) Int. Cl. B60R 25/04; E05F 15/20

(52) U.S. Cl. CPC B60R 25/04; E05F 15/2076
USPC 701/2

(57) ABSTRACT

A portable key switchable between a first mode and a second mode for operating a vehicle has a transmission antenna that transmits a signal to the vehicle, a reception antenna that receives a signal from the vehicle, a changeover switch that is operable by a user when the portable key is switched from a first mode to a second mode, a command switch that is operable by the user when an operation command signal is transmitted to the vehicle, a lighting display part that notifies the user of information, and a controller that performs control so as to transmit the signal from the transmission antenna based on input from the changeover switch or the command switch, and performs control so as to display information received from the vehicle by the reception antenna on the lighting display part.

### BACKGROUND OF THE INVENTION

1. Technical Field

The present invention relates to a vehicle portable key, particularly to a portable key switchable between two modes for operating a vehicle.

2. Related Art

Conventionally, there is well known a portable key (FOB) that wirelessly communicates with a vehicle to perform various operations to the vehicle or to display information from the vehicle. Japanese Unexamined Patent Publication No. 2004-211648 discloses a remote start/stop control device aimed at restraining a theft to the minimum. The remote start/stop control device includes a portable key having both a remote keyless entry function (hereinafter referred to as keyless function) of transmitting a command to, for example, lock or unlock a door from a place comparatively near the vehicle and operating the door and a remote start/stop function of, for example, starting or stopping an engine from a place comparatively distant from the vehicle. The remote start/stop control device includes a part that supplies a key code to an immobilizer when the portable key transmits an engine start command by remote control and a part that prohibits the supply of the key code when the vehicle is stolen.

Japanese Unexamined Patent Publication No. 2012-007443 discloses a door lock system aimed at performing high-reliability answer back. In the door lock system, the portable key transmits an instruction according to the user operation, a door lock control device drives a door lock mechanism to lock or unlock the door according to the instruction, the door lock control device transmits a notification of operation completion to the portable key, and the portable key informs the user by blinking a lamp according to the notification.

Japanese Unexamined Patent Publication No. 2004-218444 discloses an on-vehicle wireless communication device aimed at implementing a fail-safe function. In the on-vehicle wireless communication device, when a mobile phone and the vehicle are distant from each other, the remote control for starting a drive engine is prohibited, and character information indicating the start or stop of the engine and a reason why the engine is stopped is displayed on a display screen of the mobile phone.

Japanese Unexamined Patent Publication No. 2007-022405 discloses a remote control device aimed at improving user-friendliness in changing a security state. In the remote control device, when the portable key performs the engine start operation and the operation to change the setting of the security state, a transmission and reception part transmits an engine start signal and a security state change signal to an on-vehicle machine. Various pieces of information such as start or stop confirmation information in remotely starting or stopping the engine, an elapsed time after the start, and the vehicle security state are displayed on the portable key.

In the case that the engine is remotely started by the remote start/stop function, because frequently the user can neither see the vehicle nor hear an engine sound at the time of operation, the user cannot confirm whether the engine is actually started by the engine start operation. Therefore, as in Japanese Unexamined Patent Publication No. 2004-218444, it is necessary to display the successful engine start on the portable key. At this point, in the portable key including the keyless function and the remote start/stop function, in addition to the display of the engine start, it is necessary to perform the display when the door lock or unlock operation is performed by the keyless function. This is because, when the user presses a lock operation button, the reception of the lock operation button and the signal transmission are to be indicated to the user.

### SUMMARY

However, when the display is performed while a display screen such as a liquid crystal display is provided in the portable key like the mobile phone, although the user can be notified of various pieces of information using character information and the like, power consumption of a battery of the portable key increases because of the liquid crystal display or the like to lead to enlargement of the portable key. One or more embodiments of the present invention provides a portable key that can display the information from the vehicle and the situation of the signal transmission with low false recognition probability in an easy-to-understand manner for the user in the portable key including the plural functions such as the keyless function and the remote start/stop function to perform the display for the purpose of notification to the user using the simple lighting display part such as the LED.

In accordance with one or more embodiments of the present invention, there is provided a portable key switchable between two modes for operating a vehicle, the portable key including: a transmission antenna that transmits a signal to the vehicle; a reception antenna that receives a signal from the vehicle; a changeover switch that is operable by a user when the portable key is switched from a first mode to a second mode of the two modes; a command switch that is operable by the user when an operation command signal is transmitted to the vehicle; a lighting display part that notifies the user of information; and a controller that performs control so as to transmit the signal from the transmission antenna based on input from the changeover switch or the command switch, and performs control so as to display the information received from vehicle by the reception antenna on the lighting display part, wherein the controller transmits a first operation command signal valid in the first mode from the transmission antenna when the command switch is operated in the first mode, the controller transmits a second operation command signal valid in the second mode from the transmission antenna, and switches the portable key to a reply waiting mode for waiting a reply signal indicating completion of operation commanded by the second operation command signal, when the command switch is operated within a predetermined time after the portable key is switched to the second mode by the operation of the changeover switch, the controller switches the portable key from the replay waiting mode to the first mode, when the reply signal is received from the vehicle or when the command switch is operated after the portable key is switched to the reply waiting mode, the controller performs display on the lighting display part, when the portable key is switched to the second mode, when the reply signal is received, and when the first operation command signal is transmitted, and the controller neither transmits the signal from the transmission antenna nor performs the display on the lighting display part, when the command switch is operated in the reply waiting mode to switch the portable key to the first mode.

Accordingly, the portable key that includes the a plurality of functions to be able to display the information from the vehicle with the low false recognition probability in the easy-to-understand manner for the user by the simple lighting display during the switching between the modes, the reception of the replay signal, and the transmission of the operation command signal can be provided.

In the portable key, the first mode may be a remote keyless entry function mode for transmitting a signal of a command to lock or unlock a door of the vehicle, the second mode may be a remote start/stop function mode for transmitting a signal of a command to start or stop an engine of the vehicle, information from the vehicle may be information on an engine driving situation, the first operation command signal may be the door lock command signal or the door unlock command signal, and the second operation command signal may be the engine start command signal or the engine stop command signal.

Accordingly, the engine driving situation and the transmission situation of the command can be displayed with the low false recognition probability in the easy-to-understand manner for the user while including a plurality of functions such as the remote keyless entry function mode and the remote start/stop function mode.

In the portable key, the controller may switch the portable key to the first mode when the operation of the changeover switch, the operation of the command switch, or the reception of the reply signal is not performed within a predetermined time after the portable key is switched to the reply waiting mode.

Accordingly, the user-friendly portable key that returns automatically to the first mode when a given operation is performed within the predetermined time or when the reply signal is not received within the predetermined time can be provided.

In the portable key, the portable key may be switched to a setting mode for setting an idling time of the engine of the vehicle by a predetermined operation of the changeover switch, and the idling time may be changed by operating one of the changeover switch and the command switch in the setting mode.

Accordingly, the setting mode can be changed by the simple operation even though the switches are small in number.

In the portable key, the controller may display a transmission situation of the signal from the transmission antenna on the lighting display part after transmitting the signal.

Accordingly, the portable key that can display the situation of the signal transmission therefrom with the low false recognition probability in the easy-to-understand manner for the user by the simple lighting display can be provided.

In the portable key, the controller may end the second mode when the command switch is not operated within the predetermined time after the portable key is switched to the second mode by the operation of the changeover switch.

Accordingly, waste power consumption can be reduced in the portable key.

As described above, one or more embodiments of the present invention can provide the portable key that can display the information from the vehicle and the situation of the signal transmission with the low false recognition probability in the easy-to-understand manner for the user in the portable key including the plural functions to perform the display for the purpose of the notification to the user using the simple lighting display part such as the LED.

### BRIEF DESCRIPTION OF THE DRAWINGS

FIG. 1 is a block diagram illustrating a portable key according to a first embodiment of the present invention;

FIG. 2 is an outline drawing illustrating the portable key of the first embodiment;

FIG. 3 is a control flowchart of the portable key of the first embodiment;

FIGS. 4A and 4B show a control flowchart of a portable key according to a second embodiment of the present invention;

FIG. 5 is a diagram illustrating an example lighting display in a remote start/stop function mode of one or more embodiments of the present invention; and

FIG. 6 is a diagram illustrating an example lighting display in a setting mode of one or more embodiments of the present invention.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

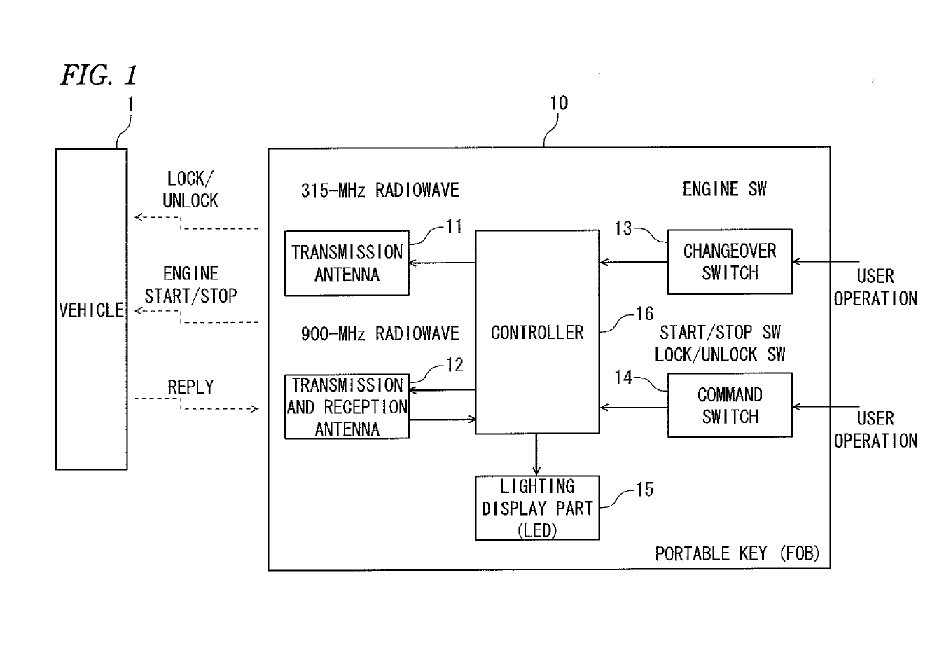

FIG. 1 is a block diagram illustrating a functional configuration of a portable key 10 according to a first embodiment. The portable key 10 receives user operation through a switch, and transmits and receives a wireless communication signal to and from a vehicle 1.

The portable key 10 of the first embodiment can switch between two modes, namely, a first mode of a remote keyless entry function mode (hereinafter referred to as a keyless function mode) for transmitting a signal of a command to lock or unlock a door of the vehicle 1 and a second mode of a remote start/stop function mode for transmitting a signal of a command to start or stop an engine of the vehicle 1. The first mode and the second mode are not limited to the above contents. For example, the first mode may be a mode for transmitting a signal of a command to open or close a window and the second mode may be a mode for transmitting a signal of a command to start or stop an air conditioner.

The portable key 10 includes a changeover switch 13 and a command switch 14, which are operable by the user. The changeover switch 13 switches the first mode to the second mode in the case that the user operates the changeover switch 13. The command switch 14 has a function of changing an operation command signal transmitted to the vehicle 1 according to the mode in which the user operates the command switch 14.

The portable key 10 also includes a controller 16, a transmission antenna 11 that transmits the signal to the vehicle 1, and a transmission and reception antenna 12 that transmits and receives the signal to and from the vehicle 1. The controller 16 performs control so as to transmit the signal from the transmission antenna 11 or the transmission and reception antenna 12 based on input from the changeover switch 13 or the command switch 14.

For example, in the case that the command switch 14 is operated in the first mode of the keyless function mode, the controller 16 transmits the door lock or unlock command signal using the transmission antenna 11 that emits a 315-MHz radiowave. In the case that the command switch 14 is operated in the second mode of the remote start/stop function mode, the controller 16 transmits the engine start or stop command signal using the transmission and reception antenna 12 that emits a 900-MHz radiowave. After transmitting the engine start or stop command signal, the controller 16 performs the control so as to receive a reply of information on an engine driving situation from the vehicle 1 through the transmission and reception antenna 12.

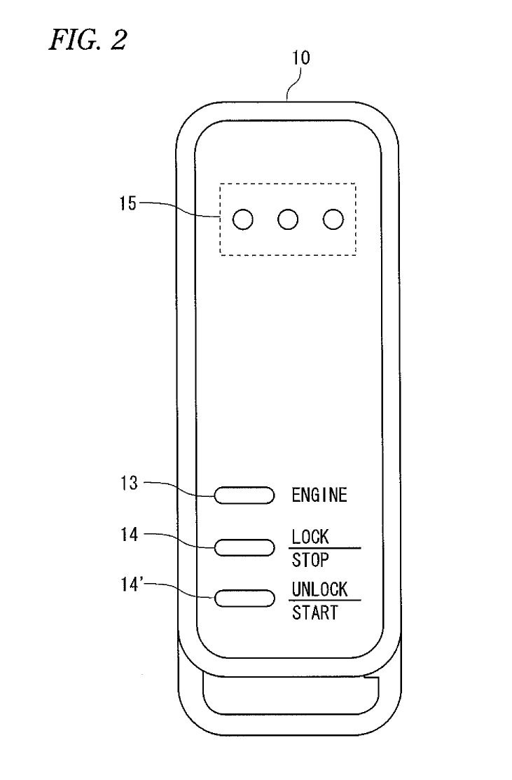

The portable key 10 also includes a lighting display part 15 that notifies the user of the information. In the first embodiment, an LED (Light Emitting Diode) is used as the lighting display part 15. The lighting display part 15 is controlled by the controller 16, and displays the information received from the vehicle 1 through the transmission and reception antenna 12 and the transmission of the command signal. In the first embodiment, as illustrated in FIG. 2, the lighting display part 15 is constructed with three LEDs, and displays various pieces of information by lighting or blinking the three LEDs. In the LED, compared with a liquid crystal display, because an information amount is decreased although power consumption is very small, it is necessary to devise a method for displaying the information. The detail is described later.

As illustrated in FIG. 2, the command switch 14 is constructed with two switches. The command switch 14 is not limited to one switch, but the command switch 14 may be at least two switches. For example, the command switch 14 for the air conditioner may have three switches of weak start, strong start, and stop. The same holds true for the changeover switch 13.

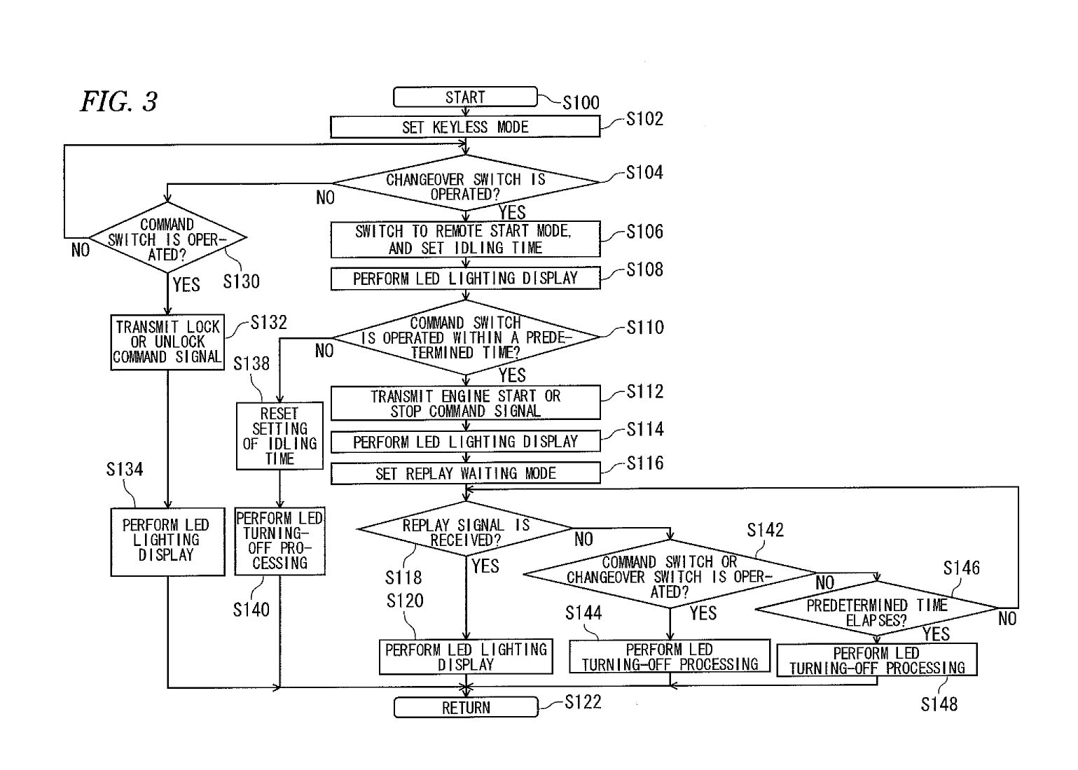

A method for controlling the controller 16 will be described with reference to a flowchart in FIG. 3. A step in the flowchart is abbreviated to S. The controller 16 is started in the first mode of the keyless function mode (S102). When the changeover switch 13 is not operated (NO in S104) and the command switch 14 is not operated (NO in S130), the controller 16 remains in the first mode of the keyless function mode.

When the changeover switch 13 is not operated and the command switch 14 is operated (YES in S130), namely, when the command switch 14 is operated in the first mode of the keyless function mode, the controller 16 transmits a lock or unlock command signal that is of the operation command signal valid in the mode to the vehicle 1 through the transmission antenna 11 in S132. The controller 16 determines which one of lock and unlock command signals is transmitted based on the operated command switch 14 or 14′ (see FIG. 2).

In S134, the controller 16 displays the transmission of the lock or unlock command signal on the lighting display part 15. In the first embodiment, because the lighting display part 15 is constructed with the three LEDs (see FIG. 2), the display method is properly decided such that the leftmost LED is lit once for the lock command signal, and such that the leftmost LED is lit twice for the unlock command signal, for example. Then, in S122, the controller 16 returns to S100 to be put into the first mode of the keyless function mode again.

When the changeover switch 13 is operated in the first mode of the keyless function mode (YES in S104), the controller 16 sets the portable key 10 to the second mode of the remote start/stop function mode in S106. According to one or more embodiments of the present invention, in order that the user intentionally operates the changeover switch 13, the operation of the changeover switch 13 that switches the portable key 10 from the first mode to the second mode is valid in the case that the user presses the changeover switch 13 for a prolonged time of about 1 second.

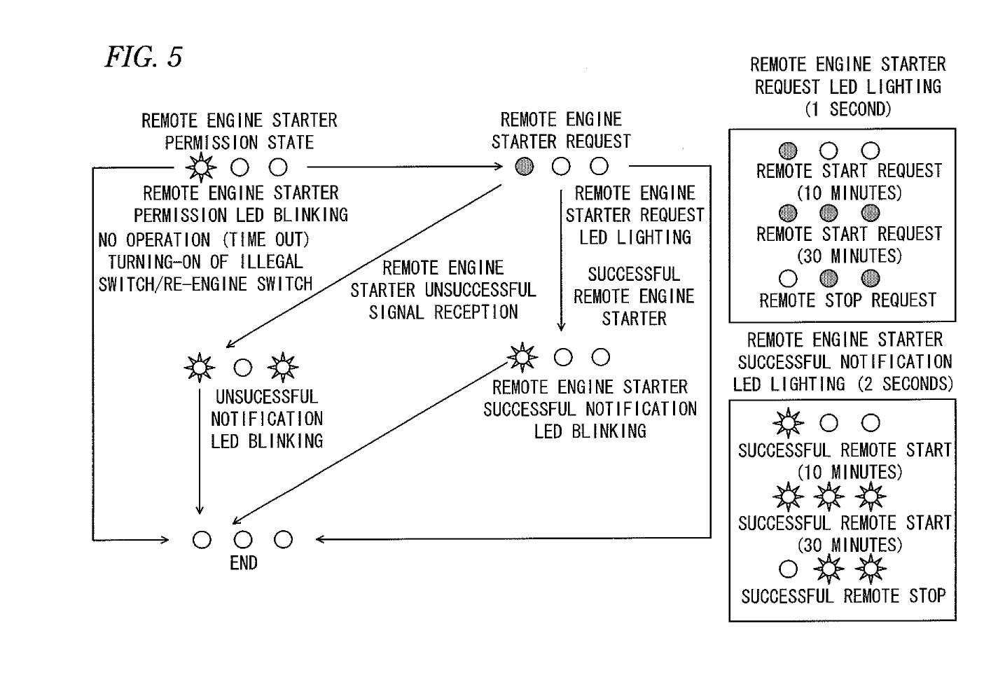

In S108, the controller 16 performs the display on the lighting display part 15 in order to notify the user that the portable key 10 is switched to the remote start/stop function mode. As to the display method, as illustrated in FIG. 5, a state (remote start/stop permission state) in which the operation command signal valid in the remote start/stop function mode can be transmitted is displayed by blinking the left LED (remote start/stop permission LED blinking). As used herein, the blinking means a repetition of lighting for about 250 ms and turning-off for about 250 ms.

In S110, the controller 16 monitors whether the command switch 14 is operated within a predetermined time after the portable key 10 is switched to the second mode of the remote start/stop function mode. As used herein, the predetermined time means a time during which the user can recognize that the portable key 10 is switched to the second mode of the remote start/stop function mode using the lighting display part 15 and operate the command switch 14, and the predetermined time is not too long on the assumption that the user intentionally operate the command switch 14. The predetermined time ranges about 2 seconds to about 5 seconds, for example.

When the command switch 14 is not operated within the predetermined time, the controller 16 resets the setting of the idling time in S138, performs turning-off processing of turning off the blinking of the left LED in S140, and notifies the user that the portable key 10 returns to the first mode of the keyless function mode. The controller 16 performs return in order to return the portable key 10 to the first mode of the keyless function mode (S122). Therefore, waste power consumption can be reduced in the portable key 10.

When the command switch 14 is operated within the predetermined time, the controller 16 transmits the command signal that is of the operation command signal valid in the second mode of the remote start/stop function mode to the vehicle 1 through the transmission and reception antenna 12 in order to start or stop the engine in S112. The controller 16 determines which one of the engine start signal and the engine stop signal is to be transmitted based on the operated command switch 14 or 14′ (see FIG. 2). Then the controller 16 performs the display on the lighting display part 15 in S114. As to the display method, as illustrated in FIG. 5, the transmission of the operation command signal valid in the remote start/stop function mode by the operation of the command switch 14 within the predetermined time is displayed by lighting the left LED (remote start/stop request LED lighting).

In S116, the controller 16 sets the portable key 10 to the reply waiting mode for waiting a reply signal indicating completion or incompletion of the operation commanded by the operation command signal transmitted in S112, namely, completion or incompletion of the start or stop of the engine. The vehicle 1 starts or stop the engine based on the engine start or stop command from the portable key 10, sends a successful reply to the portable key 10 when the operation is completed, and sends an unsuccessful reply to the portable key 10 when the operation is not completed. Usually it takes 3 seconds to 5 seconds for the vehicle 1 to send the reply since receiving the operation command signal.

In S118, the controller 16 monitors whether the reply signal is sent back from the vehicle 1 through the transmission and reception antenna 12. When the reply signal is sent back, the controller 16 performs the display on the lighting display part 15 in order to notify the user of the result in S120. As to the display method, as illustrated in FIG. 5, the indication of the successful operation is displayed by blinking the left LED (remote start/stop successful notification LED blinking). On the other hand, the indication of the unsuccessful operation is displayed by blinking the right and left LEDs (unsuccessful notification LED blinking). In S122, the controller 16 returns to S100 to switch the portable key 10 from the reply waiting mode to the first mode of the keyless function mode.

When the user operates the command switch 14 while the reply signal is not yet received from the vehicle 1 (YES in S142), the controller 16 performs processing of turning off the lighting display part 15 in S144, and notifies the user that the portable key 10 returns from the replay waiting mode to the first mode of the keyless function mode. Then the controller 16 performs the return in order to return the portable key 10 to the first mode of the keyless function mode (S122). Basically the user operation of the command switch 14 is invalid in the replay waiting mode. Accordingly, because of the invalid operation, the controller 16 neither transmits any of the signals from the transmission antenna 11 or the transmission and reception antenna 12 nor performs the display on the lighting display part 15. Therefore, the controller 16 cancels the replay waiting mode, and the lighting is not performed even if the command switch 14 is pressed, which allows the user to pay attention to the performance of the invalid operation. When the user operates the changeover switch 13 while the reply signal is not yet received from the vehicle 1 (YES in S142), the controller 16 also performs the processing of turning off the lighting display part 15 in S144, and notifies the user that the portable key 10 returns from the replay waiting mode to the first mode of the keyless function mode (S122).

The portable key that includes the plural functions of the remote keyless entry function mode and the remote start/stop function mode to be able to display the information on the engine driving situation from the vehicle and situations of the successful or unsuccessful transmission and reception of the command signal with the low false recognition probability in the easy-to-understand manner for the user by the simple lighting display during the switching between the modes, the reception of the replay signal, and the transmission of the operation command signal can be provided in a manner such that the controller 16 performs the above control.

The controller 16 waits for the reply signal from the vehicle 1 for the predetermined time as long as the switch is not operated in the reply waiting mode. On the other hand, when the operation of the changeover switch 13, the operation of the command switch 14, and the reception of the reply signal are not performed within the predetermined time after the portable key is switched to the reply waiting mode (NO in S118, NO in S142, and YES in S146), the reply waiting mode becomes time-out. In this case, the controller 16 performs the turning-off processing of the lighting display part 15 to notify the user that the portable key returns from the reply waiting mode to the first mode of the keyless function mode in S148. The controller 16 performs the return in order to return the portable key 10 to the first mode of the keyless function mode (S122). The user-friendly portable key can be provided such that the portable key returns automatically to the first mode in the case that the given operation is performed within the predetermined time or that the reply signal is not received.

In S106, by performing the predetermined operation of the changeover switch 13, the controller 16 can switch the portable key to the setting mode for setting the idling time after the engine of the vehicle 1 is started. For example, only the left LED of the lighting display part 15 is lit when the changeover switch 13 is operated once, and the idling time for 10 minutes is set to transmit the signal to the vehicle 1 when the command switch 14 or 14′ is operated while the left LED is lit. The left and central LEDs are lit when the changeover switch 13 is operated twice, and the idling time for 20 minutes is set to transmit the signal to the vehicle 1 when the command switch 14 or 14′ is operated while the left and central LEDs are lit. All the LEDs are lit when the changeover switch 13 is operated three times, and the idling time for 30 minutes is set to transmit the signal to the vehicle 1 when the command switch 14 or 14′ is operated while all the LEDs are lit.

In the case that the operation command is the engine stop command, the controller 16 lights the central and right LEDs for the remote start/stop request LED lighting, and blinks the central and right LEDs for the remote start/stop successful LED blinking.

### Second Embodiment

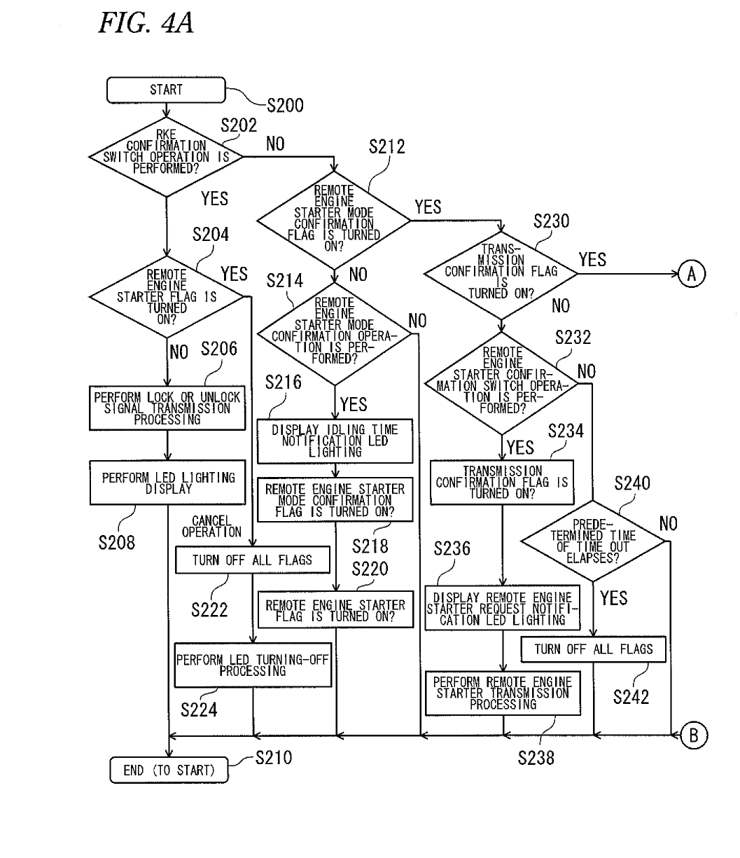

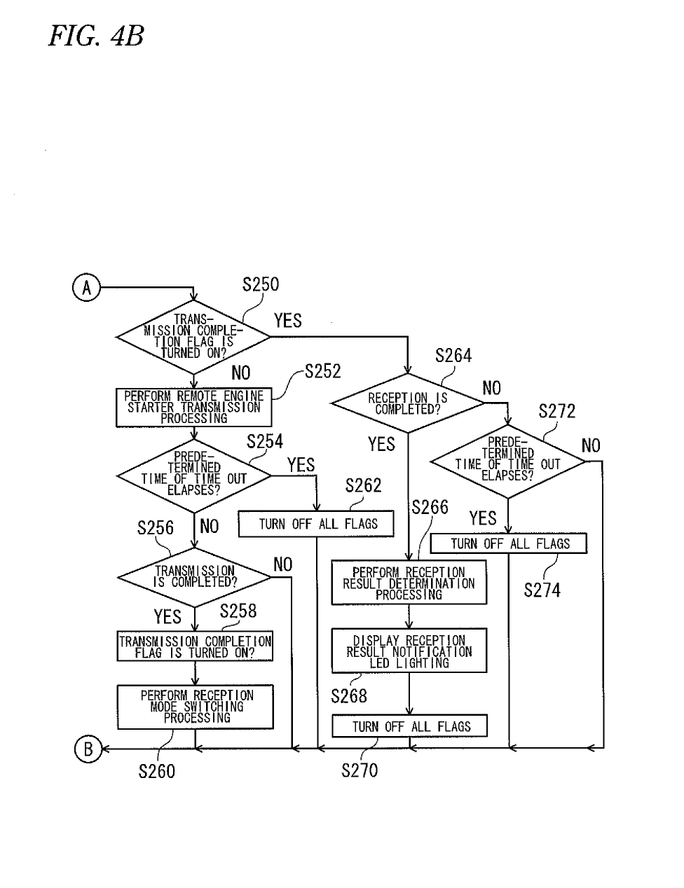

A method for controlling a controller according to a second embodiment will be described below with reference to a flowchart in FIGS. 4A and 4B. The overlapping description is avoided, and a portion different from that of the first embodiment is mainly described. The components constituting the portable key of the second embodiment are similar to those of the portable key 10 of the first embodiment in FIG. 1. Hereinafter, the controller of the second embodiment is designated by the numeral 16′ because only the controller of the second embodiment is distinguished from the controller of the first embodiment.

Similarly to the first embodiment, the controller 16′ in the initial state is started in the remote keyless entry (RKE) function mode. When the command switch 14 for confirming the RKE function mode is operated (YES in S202), the controller 16′ checks whether a remote start/stop flag is in an on state in S204. At this point, because the remote start/stop flag is not in the on state, the controller 16′ transmits the lock signal or the unlock signal according to the command switch 14 or 14′ operated in S202 (S206). In S208, the controller 16′ performs the display on the lighting display part 15 similarly to the S134 of the first embodiment. After the display, the controller 16′ returns to START (S210).

When the changeover switch 13 is operated (NO in S202), the controller 16′ checks whether a remote start/stop mode decision flag is in the on state in S212. At this point, because the remote start/stop mode decision flag is not in the on state, the controller 16′ checks whether the command switch 14 or 14′ is operated in order to confirm the remote start/stop mode in S214. When the command switch 14 or 14′ is operated, the controller 16′ displays the previously-set idling time on the lighting display part 15 in S216. The controller 16′ puts the remote start/stop mode decision flag into the on state in S218. The controller 16′ puts the remote start/stop flag into the on state in S220, namely, the portable key is switched from the keyless function mode to the remote start/stop function mode to perform the return. When the command switches 14 and 14′ are not operated (NO in S214), namely, when the remote start/stop mode becomes the time-out, S216 to S220 are skipped to perform the return.

After returning to START (S200), the controller 16′ checks whether a transmission decision flag is in the on state in S230 because the remote start/stop mode decision flag is in the on state this time (YES in S212). At this point, because the transmission decision flag is not in the on state, the controller 16′ checks whether the command switch 14 or 14′ that is of the remote start/stop decision switch is operated in S232.

When the command switch is operated (YES in S232), the controller 16′ puts the transmission decision flag into the on state in S234. The controller 16′ displays a remote start/stop request notification on the lighting display part 15 in S236, and transmits the engine start or stop command as remote start/stop transmission processing in S238. Then the controller 16′ performs the return. On the other hand, when the command switches 14 and 14′ are not operated (NO in S232), the controller 16′ checks whether the predetermined time of the time-out elapses in S240. When the predetermined time does not elapse, the controller 16′ performs the return without performing anything while the portable key remains in the remote start/stop function mode. On the other hand, when the predetermined time elapses, all the flags are turned off to turn off the remote start/stop flag (S242), namely the portable key is switched from the remote start/stop function mode to the keyless function mode, and the controller 16′ performs the return.

When the predetermined time of the time-out does not elapse, because the transmission decision flag is in the on state this time (YES in S230), the controller 16′ checks whether a transmission completion flag is in the on state in S250. When the transmission is not completed yet, the controller 16′ transmits the engine start or stop command again in S252. The controller 16′ also checks whether the predetermined time of the time-out elapses in S254. When the predetermined time of the time-out elapses, all the flags are turned off to turn off the remote start/stop flag (S262), namely the portable key is switched from the remote start/stop function mode to the keyless function mode, and the controller 16′ performs the return. When the predetermined time of the time-out does not elapse, the controller 16′ checks whether the transmission is completed in S256. When the transmission is not completed, the controller 16′ performs the return. When the transmission is completed, the controller 16′ turns on the transmission completion flag in S258, and performs reception mode switching processing of switching the portable key to the reply waiting mode in S260. Then the controller 16′ performs the return.

After returning to START (S200), the controller 16′ checks whether the reception of the signal indicating whether the engine is normally started from the vehicle 1 is completed in S264 because the transmission completion flag is in the on state this time (YES in S250). When the reception of the signal is not completed yet, the controller 16′ waits for the time-out in S272. When the predetermined time of the time-out elapses, all the flags are turned off in S274, and the controller 16′ switches the portable key from the reply waiting mode to the keyless function mode.

When reception of the signal is completed in S264, the controller 16′ performs reception result determination processing of determining whether the engine is normally started in S266, and performs the display on the lighting display part 15 according to the result of the reception result determination processing in S268. In S270, the controller 16′ puts all the flags into the off state to switch the portable key from the reply waiting mode to the keyless function mode. Then the controller 16′ returns to START.

When the command switch 14 or 14′ is operated before the transmission is completed in S256 or before the transmission is completed in S264, the controller 16′ makes an affirmative determination in S202 to go to S204. Because the remote start/stop flag is in the on state in S204, the controller 16′ determines that the invalid operation is performed, and performs the cancel operation. In the cancel operation, all the flags are turned off in S222, the display is not performed on the lighting display part 15 in S224, and the return is performed without transmitting any signal. Therefore, the controller 16′ cancels the replay waiting mode to switch the portable key 10 to the keyless function mode. The lighting display part 15 does not perform the lighting even if the command switch 14 is pressed, which allows the user to pay attention to the performance of the invalid operation.

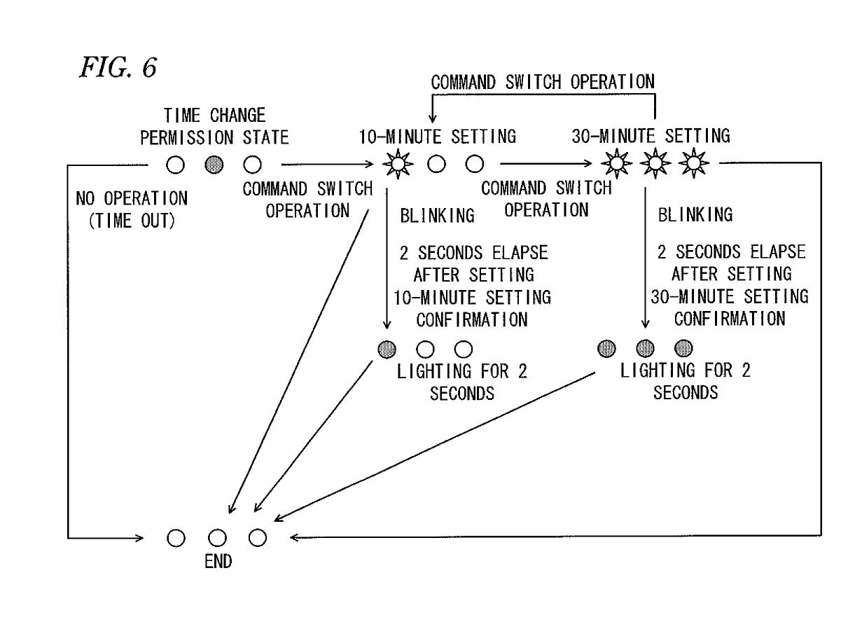

The idling time displayed by lighting in S216 is set as follows. The controller 16′ can switch the portable key to the setting mode for setting the idling time of the engine of the vehicle 1 by the predetermined operation performed on the changeover switch 13 (for example, the changeover switch 13 is pressed for a prolonged time of at least 3 seconds). The controller 16′ performs the display on the lighting display part 15 in order to exhibit the user that the portable key enters the setting mode similarly to the case of exhibiting the entry to the remote start/stop function mode. As to the display method, as illustrated in FIG. 6, the state (time change permission state) in which the idling time of the engine can be changed in the setting mode is displayed by lighting the central LED.

The controller 16′ changes the idling time of the engine when the predetermined switch operation is performed in the setting mode. For example, when the user operates the command switch 14 once in the setting mode, the idling time tentatively becomes 10 minutes, and then the idling time for 10 minutes is confirmed unless the operation is performed within a predetermined time (for example, 2 seconds). When the command switch 14 is further operated before the predetermined time elapses, another idling time can be set (FIG. 6 illustrates that the idling time for 10 minutes or 30 minutes can be set). Therefore, the setting mode can be changed by the simple operation even though the switches are small in number.

Also in the setting mode, because the user is notified using the simple lighting display part of the LED, the user easily understands the notification with a low false recognition probability. For example, as illustrated in FIG. 6, for the idling time of 10 minutes, the left LED is blinked before the confirmation, and the left LED is lit after the confirmation. For the idling time of 30 minutes, the three LEDs are blinked before the confirmation, and the three LED are lit after the confirmation.

The controller 16′ changes the display on the lighting display part 15 according to the set idling time. As to the display method in the case of the remote start/stop request LED lighting, as illustrated in the right side of FIG. 5, the left LED is lit for the idling time of 10 minutes, and all the three LEDs are lit for the idling time of 30 minutes. As to the display method in the case of the remote start/stop successful notification LED blinking, the left LED is blinked for the idling time of 10 minutes, and all the three LEDs are blinked for the idling time of 30 minutes.

The present invention is not limited to the embodiments, and any configuration can be made without departing from the scope of the claims. That is, in the present invention, although the specific embodiments are mainly illustrated in the drawings and described, those skilled in the art can make various modifications of the above embodiments in the number of components and other detailed configurations without departing from the technical thought or the range of the invention.

The remote keyless entry function and the remote start/stop function in which the radiowave is transmitted to the vehicle when the switch is operated in the portable key are described by way of example. When the invalid operation is performed after the portable key transmits the radiowave signal, the radiowave transmission to be performed by the operation and the display on the lighting display part are not performed. However, one or more embodiments of the present invention can also be applied to a passive entry function that is exerted when the vehicle emits the radiowave. For example, when the replay request signal is received from the vehicle relating to the passive entry function immediately after the engine start command signal is transmitted, the cancel operation is performed in response to the initial replay request signal, and the replay may be started in response to the second-time replay request signal.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A portable key switchable between a first mode and a second mode for operating a vehicle, the portable key comprising:
a transmission antenna that transmits a signal to the vehicle;
a reception antenna that receives a signal from the vehicle;
a changeover switch that is operable by a user when the portable key is switched from the first mode to the second mode;
a command switch that is operable by the user when an operation command signal is transmitted to the vehicle;
a lighting display part that notifies the user of information; and
a controller that performs control so as to transmit the signal from the transmission antenna based on input from the changeover switch or the command switch, and performs control so as to display information received from the vehicle by the reception antenna on the lighting display part,
wherein the controller transmits a first operation command signal valid in the first mode from the transmission antenna when the command switch is operated in the first mode,
wherein the controller transmits a second operation command signal valid in the second mode from the transmission antenna, and switches the portable key to a reply waiting mode for waiting a reply signal indicating completion of operation commanded by the second operation command signal, when the command switch is operated within a predetermined time after the portable key is switched to the second mode by the operation of the changeover switch,
wherein the controller switches the portable key from the replay waiting mode to the first mode, when the reply signal is received from the vehicle or when the command switch is operated after the portable key is switched to the reply waiting mode,
wherein the controller performs display on the lighting display part, when the portable key is switched to the second mode, when the reply signal is received, and when the first operation command signal is transmitted, and
wherein the controller neither transmits the signal from the transmission antenna nor performs the display on the lighting display part, when the command switch is operated in the reply waiting mode to switch the portable key to the first mode.

2. The portable key according to claim 1,
wherein the first mode is a remote keyless entry function mode for transmitting a signal of a command to lock or unlock a door of the vehicle,
wherein the second mode is a remote start/stop function mode for transmitting a signal of a command to start or stop an engine of the vehicle,
wherein the information from the vehicle is information on an engine driving situation,
wherein the first operation command signal is the door lock command signal or the door unlock command signal, and
wherein the second operation command signal is the engine start command signal or the engine stop command signal.

3. The portable key according to claim 1, wherein the controller switches the portable key to the first mode when the operation of the changeover switch, the operation of the command switch, or the reception of the reply signal is not performed within a predetermined time after the portable key is switched to the reply waiting mode.

4. The portable key according to claim 2,
wherein the portable key is switched to a setting mode for setting an idling time of the engine of the vehicle by a predetermined operation of the changeover switch, and
wherein the idling time is changed by operating of one of the changeover switch and the command switch in the setting mode.

5. The portable key according to claim 1, wherein the controller displays a transmission situation of the signal from the transmission antenna on the lighting display part after transmitting the signal.

6. The portable key according to claim 1, wherein the controller ends the second mode when the command switch is not operated within the predetermined time after the portable key is switched to the second mode by the operation of the changeover switch.

7. The portable key according to claim 2, wherein the controller switches the portable key to the first mode when the operation of the changeover switch, the operation of the command switch, or the reception of the reply signal is not performed within a predetermined time after the portable key is switched to the reply waiting mode.

8. The portable key according to claim 3,
wherein the portable key is switched to a setting mode for setting an idling time of the engine of the vehicle by a predetermined operation of the changeover switch, and
wherein the idling time is changed by operating of one of the changeover switch and the command switch in the setting mode.

9. The portable key according to claim 2, wherein the controller displays a transmission situation of the signal from the transmission antenna on the lighting display part after transmitting the signal.

10. The portable key according to claim 3, wherein the controller displays a transmission situation of the signal from the transmission antenna on the lighting display part after transmitting the signal.

11. The portable key according to claim 4, wherein the controller displays a transmission situation of the signal from the transmission antenna on the lighting display part after transmitting the signal.

12. The portable key according to claim 2, wherein the controller ends the second mode when the command switch is not operated within the predetermined time after the portable key is switched to the second mode by the operation of the changeover switch.

13. The portable key according to claim 3, wherein the controller ends the second mode when the command switch is not operated within the predetermined time after the portable key is switched to the second mode by the operation of the changeover switch.

14. The portable key according to claim 4, wherein the controller ends the second mode when the command switch is not operated within the predetermined time after the portable key is switched to the second mode by the operation of the changeover switch.

15. The portable key according to claim 5, wherein the controller ends the second mode when the command switch is not operated within the predetermined time after the portable key is switched to the second mode by the operation of the changeover switch.
